(19) United States
(12) Patent Application Publication
(10) Pub. No.: US 2021/0293264 A1
(43) Pub. Date: Sep. 23, 2021

(54) ENGAGEMENT STRUCTURE

(71) Applicant: FALTEC Co. Ltd., Kawasaki-shi (JP)

(72) Inventor: Tomoaki AKAIDA, Zama-shi (JP)

(21) Appl. No.: 17/205,326

(22) Filed: Mar. 18, 2021

(30) Foreign Application Priority Data
Mar. 23, 2020 (JP) 2020-050928

(51) Int. Cl. F16B 5/06; B60R 19/52

(52) U.S. Cl. CPC F16B 5/0621; B60R 2019/525; B60R 19/52

(57) ABSTRACT

An engagement structure, through which members mounted on a vehicle are engaged with each other, includes: a claw portion; and a locking portion in which at least a top layer thereof is formed of a material different from a top layer of the claw portion and on which the claw portion is locked, wherein either one of the claw portion and the locking portion includes a protrusion in which a tip thereof heads toward and contacts the other of the claw portion and the locking portion, and the claw portion is locked on the locking portion by the tip of the protrusion contacting the other of the claw portion and the locking portion.

### CROSS-REFERENCE TO REALTED APPLICATIONS

The present application claims the benefit of and priority to Japanese Patent Application No. 2020-050928, filed Mar. 23, 2020, the entire contents of which is incorporated herein by reference.

### BACKGROUND

The present invention relates to an engagement structure.

For example, Japanese Unexamined Patent Application, First Publication No. S62-30961 discloses a vehicle that includes a radiator grill formed of resin. That is, the vehicle is mounted with various exterior components such as the radiator grill. For example, some large exterior components are fixed to the vehicle body frame. On the other hand, some small exterior components or the like are fixed to other exterior components. In a case where the exterior components are connected to each other in this way, for example, a claw portion provided on either one of the exterior components may be locked on a locking portion provided on the other of the exterior components. According to this structure, the number of connection points using fastening members such as bolts can be reduced, and the exterior components can be easily connected to each other.

However, when the surface of one exterior component and the surface of another exterior component are formed of different materials, a difference occurs between the friction coefficients on the surfaces of the one and the other exterior components. As a result, the one and the other exterior components may slide against each other due to vibrations of the vehicle during traveling or the like, and thus squeaking noises may occur. For example, in a case where an exterior component with resin exposed at the surface thereof and another exterior component with metal plating on the surface thereof are connected by locking the claw portion on the locking portion as described above, the difference in friction coefficient may increase, and squeaking noises may easily occur.

The present invention is made in view of the above problems, and an object thereof is to provide an engagement structure through which members mounted on a vehicle are engaged with each other and in which the generation of squeaking noises can be limited.

### SUMMARY

In the present invention, the following configurations are adopted as means for solving the above problems.

A first aspect of the present invention is an engagement structure through which members mounted on a vehicle are engaged with each other, the engagement structure including: a claw portion; and a locking portion in which at least a top layer thereof is formed of a material different from a top layer of the claw portion and on which the claw portion is locked, wherein either one of the claw portion and the locking portion includes a protrusion in which a tip thereof heads toward and contacts the other of the claw portion and the locking portion, and the claw portion is locked on the locking portion by the tip of the protrusion contacting the other of the claw portion and the locking portion.

A second aspect of the present invention is that in the first aspect, the either one of the claw portion and the locking portion includes a plate-shaped base supporting the protrusion, and the protrusion is erected on a surface of the base, and the tip is provided so as to head in a first direction parallel to the surface of the base.

A third aspect of the present invention is that in the second aspect, the tip is arranged at an end of the protrusion in a second direction parallel to the surface of the base and orthogonal to the first direction in which the tip heads.

A fourth aspect of the present invention is that in the second or third aspect, a surface of the protrusion at an end thereof in a second direction parallel to the surface of the base and orthogonal to the first direction in which the tip heads is flush with a surface of the base at an end thereof in the second direction.

A fifth aspect of the present invention is that in any one of the first to fourth aspects, at least the top layer of the locking portion is formed of resin, and the top layer of the claw portion is formed of a metal plating layer.

A sixth aspect of the present invention is that in the first aspect, the tip is formed such that the width and the protrusion amount of the protrusion decrease toward the locking portion.

According to the present invention, either one of the claw portion and the locking portion to be locked on each other is provided with the protrusion, and the tip of the protrusion contacts the other of the claw portion and the locking portion, whereby the claw portion and the locking portion are locked on each other. Therefore, the contact area between the claw portion and the locking portion can be decreased compared to a state where the claw portion and the locking portion are not provided with the protrusion including the tip. Thus, according to the present invention, squeaking noises can be limited from occurring when the claw portion and the locking portion slide against each other. Consequently, according to the present invention, in an engagement structure through which members mounted on a vehicle are engaged with each other, the generation of squeaking noises can be limited.

### BRIEF DESCRIPTION OF THE DRAWINGS

FIG. 1 is a schematic front view of a radiator grill and a molding engaged by an engagement structure of an embodiment of the present invention.

FIG. 2 is a perspective view showing a schematic configuration of the engagement structure of the embodiment of the present invention.

FIG. 3 is a view of the engagement structure of the embodiment of the present invention as viewed in the direction of arrow A shown in FIG. 2.

FIG. 4 is a view of a modification of the engagement structure of the embodiment of the present invention as viewed in the direction of arrow A shown in FIG. 2.

### DETAILED DESCRIPTION

Hereinafter, an embodiment of an engagement structure of the present invention is described with reference to the drawings.

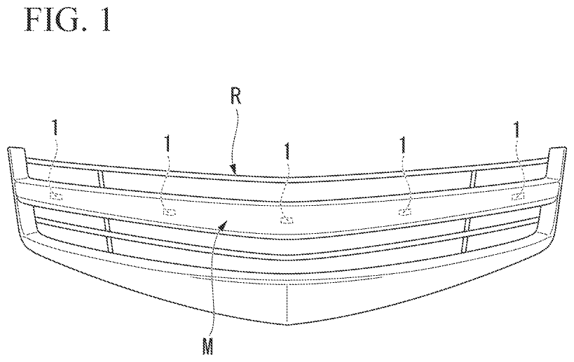

FIG. 1 is a schematic front view of a radiator grill R (first member) and a molding M (second member) engaged by an engagement structure 1 of this embodiment. The radiator grill R is provided in the center of the front of a vehicle and is arranged in front of a radiator provided inside the engine room. In this embodiment, the radiator grill R is formed through injection molding of resin, and the resin is exposed. That is, in this embodiment, the entire radiator grill R including the top layer thereof is formed of resin.

The molding M is a member connected to the radiator grill R through the engagement structure 1. In this embodiment, the molding M is a member in which plating is applied to the surface of a resin body, and the top layer thereof is formed of a metal plating layer. That is, in this embodiment, the top layer of the molding M is formed of a material different from the radiator grill R (the top layer of the radiator grill R).

The engagement structure 1 of this embodiment is a structure used to connect the radiator grill R and the molding M to each other, and as shown in FIG. 1, a plurality of engagement structures 1 are provided in another structure assembled from the radiator grill R and the molding M. More specifically, in this embodiment, the molding M has an elongated shape in a vehicle width direction, and the plurality of engagement structures 1 are arranged at intervals in the longitudinal direction of the molding M.

The engaged members (the radiator grill R and the molding M) and the arrangement of the engagement structure 1 of this embodiment are just examples. It is also possible to connect other exterior components mounted on the vehicle through the engagement structure 1 of this embodiment. The arrangement of the engagement structure 1 can be changed according to exterior components to be engaged.

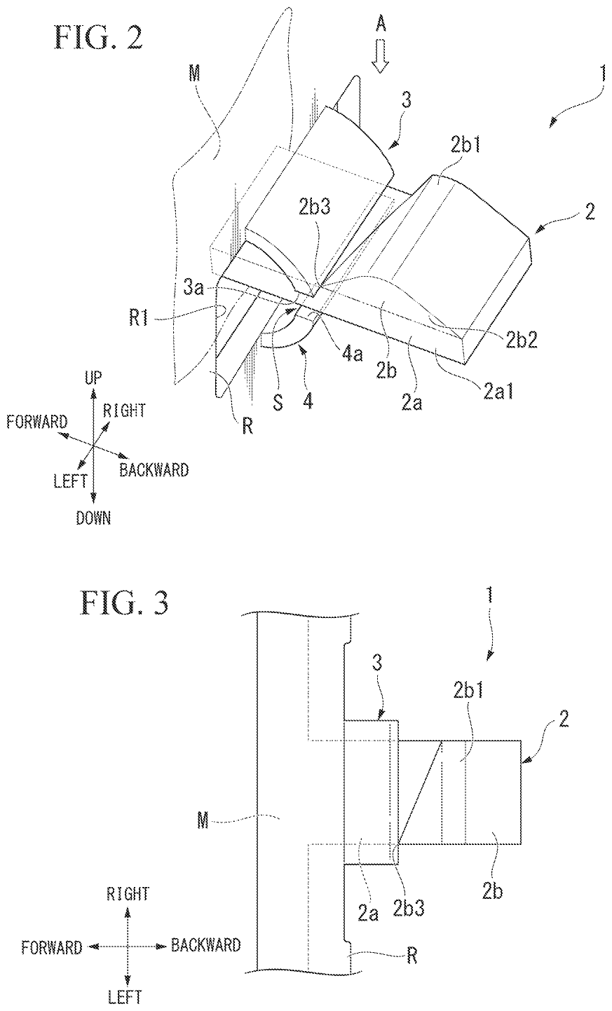

FIG. 2 is a perspective view showing a schematic configuration of the engagement structure 1 of this embodiment. FIG. 3 is a view of the engagement structure 1 of this embodiment as viewed in the direction of arrow A shown in FIG. 2. As shown in these drawings, the engagement structure 1 includes a claw portion 2 provided in the molding M and a locking piece 3 (locking portion) provided in the radiator grill R. In this embodiment, the engagement structure 1 includes an opposite piece 4, and the opposite piece 4 is provided in the radiator grill R so as to face the locking piece 3. Since the claw portion 2 is integrally provided in the molding M, the claw portion 2 has a structure in which metal plating is applied to the surface of a resin body similar to the molding M. That is, the top layer of the claw portion 2 is formed of a metal plating layer. On the other hand, since the locking piece 3 is integrally provided in the radiator grill R, the entire locking piece 3 including the top layer thereof is formed of resin similar to the radiator grill R. That is, in the engagement structure 1 of this embodiment, the top layer of the claw portion 2 is formed of a material different from the locking piece 3 (the top layer of the locking piece 3). Since the opposite piece 4 is also integrally provided in the radiator grill R, the entire opposite piece 4 including the top layer thereof is formed of resin similar to the radiator grill R.

The claw portion 2 includes a plate-shaped base 2a having a rectangular shape in plan view and a protrusion 2b provided on an end of the base 2a. The base 2a extends perpendicularly from a surface facing backward of a main body (the portion other than the claw portion 2) of the molding M, and the base end of the base 2a is connected to the main body of the molding M. The base 2a supports the protrusion 2b provided on the end thereof.

The arrangement posture of the engagement structure 1 of this embodiment (i.e., the arrangement posture of the claw portion 2) is not particularly limited. However, in the following description, as shown in FIGS. 2 and 3, for convenience of explanation, a direction parallel to a direction in which a surface of the plate-shaped base 2a (the surface provided with the protrusion 2b) faces is referred to as an up-down direction, a direction parallel to a direction in which the base 2a extends from the main body of the molding M is referred to as a forward-backward direction (first direction), and a direction orthogonal to the up-down direction and the forward-backward direction is referred to as a left-right direction (second direction). The plan view is a view as viewed in the up-down direction.

The protrusion 2b is a portion erected upward from the upper surface (surface) of the base 2a. When viewed from the left, the protrusion 2b has a substantially mountain shape in which a top 2b1 positioned at the center thereof in the forward-backward direction bulges upward. Side surfaces 2b2 at both ends in the left-right direction of the protrusion 2b are flush with side surfaces 2a1 at both ends in the left-right direction of the base 2a.

In this embodiment, as shown in FIGS. 2 and 3, the protrusion 2b includes a tip 2b3 heading forward (i.e., toward the locking piece 3). The tip 2b3 is formed such that both of the width in the left-right direction and the protrusion amount (height) in the up-down direction of a portion of the protrusion 2b positioned in front of the top 2b1 decrease toward the front. In other words, the width in the left-right direction and the protrusion amount (height) in the up-down direction of the protrusion 2b decrease toward the tip 2b3. The tip 2b3 of the protrusion 2b formed in this way is a portion of the claw portion 2 that contacts the locking piece 3. That is, in this embodiment, the claw portion 2 includes the protrusion 2b in which the tip 2b3 heads toward and contacts the locking piece 3, and the claw portion 2 is locked on the locking piece 3 by the tip 2b3 of the protrusion 2b contacting the locking piece 3.

As shown in FIG. 2, the protrusion amount, which is upward from the upper surface of the base 2a, of a portion of the protrusion 2b positioned behind the top 2b1 decreases backward. Thereby, the claw portion 2 can be easily inserted into a gap S described later between the locking piece 3 and the opposite piece 4.

As shown in FIG. 2, the main body of the radiator grill R is provided with an opening R1 through which the claw portion 2 is inserted. The locking piece 3 is a flexible plate-shaped portion that is arranged above the opening R1 and extends backward from the main body of the radiator grill R. The locking piece 3 is curved so as to head downward as it goes backward, and an end surface 3a thereof faces downward. On the locking piece 3, the tip 2b3 of the claw portion 2 inserted through the opening R1 is locked from the back side.

The opposite piece 4 is a flexible plate-shaped portion that is arranged below the opening R1 and extends backward from the main body of the radiator grill R. The opposite piece 4 is curved so as to head upward as it goes backward, and an end surface 4a thereof faces upward in a state where the gap S constant in the up-down direction is provided between the end surface 3a of the locking piece 3 and the end surface 4a.

The locking piece 3 and the opposite piece 4 are arranged facing each other in the up-down direction, and the gap S is formed between the end surfaces 3a and 4a. At the time the claw portion 2 is inserted, when the protrusion 2b of the claw portion 2 is inserted into the gap S, the locking piece 3 and the opposite piece 4 are elastically deformed to increase the gap S. Subsequently, after the protrusion 2b passes through the gap S, the locking piece 3 and the opposite piece 4 return to their original shapes, and the gap S decreases. When the gap S decreases, the tip 2b3 of the protrusion 2b of the claw portion 2 is locked on the locking piece 3 from behind, and thus the protrusion 2b is prevented from unintentionally coming out of the gap S.

The engagement structure 1 of this embodiment as described above is an engagement structure between the radiator grill R mounted on the vehicle and the molding M in which at least the top layer thereof is formed of a material different from the radiator grill R. The engagement structure 1 of this embodiment includes the claw portion 2 provided in the molding M and the locking piece 3 that is provided in the radiator grill R and on which the claw portion 2 is locked, the claw portion 2 includes the protrusion 2b in which the tip 2b3 heads toward and contacts the locking piece 3, and the claw portion 2 is locked on the locking piece 3 by the tip 2b3 of the protrusion 2b contacting the locking piece 3.

According to the engagement structure 1 of this embodiment, the claw portion 2 among the claw portion 2 and the locking piece 3 to be locked on each other is provided with the protrusion 2b, and the claw portion 2 and the locking piece 3 are locked on each other by the tip 2b3 of the protrusion 2b contacting the locking piece 3. Therefore, the contact area between the radiator grill R and the molding M can be decreased compared to a state where the claw portion 2 is not provided with the protrusion 2b including the tip 2b3. In contrast, in a case where the tip 2b3 is not provided, the claw portion 2 and the locking piece 3 contact each other at a continuous area in the left-right direction, and they contact each other at a wide area in the left-right direction. Thus, according to the engagement structure 1 of this embodiment, squeaking noises can be limited from occurring when the radiator grill R and the molding M slide against each other.

In the engagement structure 1 of this embodiment, the claw portion 2 includes the protrusion 2b and the plate-shaped base 2a supporting the protrusion 2b, the protrusion 2b is erected on the surface of the base 2a, and the tip 2b3 is provided so as to head in a first direction (in this embodiment, forward direction) parallel to the surface of the base 2a. According to the engagement structure 1 of this embodiment, the base 2a can be limited from bending due to a reaction force that the protrusion 2b receives from the locking piece 3, and the engagement state between the claw portion 2 and the locking piece 3 can be more reliably maintained.

In the engagement structure 1 of this embodiment, the tip 2b3 is arranged at an end of the protrusion 2b in a second direction (in this embodiment, the left-right direction) parallel to the surface of the base 2a and orthogonal to the first direction in which the tip 2b3 heads. According to the engagement structure 1 of this embodiment, when the protrusion 2b is formed through injection molding, slide cores do not have to be arranged on both sides in the left-right direction of the tip 2b3. Therefore, according to the engagement structure 1 of this embodiment, the molding M can be easily manufactured.

In the engagement structure 1 of this embodiment, a surface (the side surface 2b2) of the protrusion 2b at an end thereof in a second direction (in this embodiment, the left-right direction) parallel to the surface of the base 2a and orthogonal to the first direction in which the tip 2b3 heads is flush with a surface (the side surface 2a1) of the base 2a at an end thereof in the second direction. Therefore, when the protrusion 2b is formed through injection molding, the surface at the end of the protrusion 2b and the surface at the end of the base 2a can be formed using one flat surface of a mold, and the shape of the mold can be simplified. Thus, according to the engagement structure 1 of this embodiment, the molding M can be easily manufactured.

In the engagement structure 1 of this embodiment, the radiator grill R is formed of resin, and the molding M has the top layer formed of a metal plating layer. Even when the resin material and the metal material are engaged with each other in this way, according to the engagement structure 1 of this embodiment, the contact area therebetween is small, and thus squeaking noises can be limited from occurring when the radiator grill R and the molding M slide against each other.

Hereinbefore, the embodiment of the present invention has been described with reference to the attached drawings, but the present invention is not limited to the above embodiment. The shape, the combination or the like of each component shown in the above embodiment is an example, and various modifications of the configuration based on a design request or the like can be adopted within the scope of the present invention.

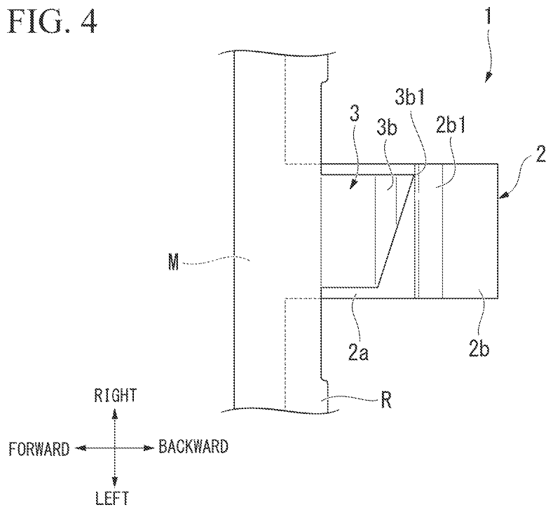

In the above embodiment, a configuration is described in which the claw portion 2 is provided with the protrusion 2b including the tip 2b3. However, the present invention is not limited to this configuration. For example, as shown in FIG. 4, the claw portion 2 may be provided with a protrusion 2b including no tip 2b3, and the locking piece 3 may be provided with a protrusion 3b in which a tip 3b1 thereof contacts the claw portion 2.

In the above embodiment, a configuration is adopted in which the molding M is provided with the claw portion 2, and the radiator grill R is provided with the locking piece 3. However, the present invention is not limited to this configuration. For example, the molding M may be provided with the locking piece 3, and the radiator grill R may be provided with the claw portion 2.

In the above embodiment, the tip 2b3 is arranged at an end of the protrusion 2b in the left-right direction, and the surface at the end of the protrusion 2b and the surface at the end of the base 2a are flush with each other, but the present invention is not limited to this configuration. A tip may be arranged at an intermediate position in the left-right direction of a protrusion. In this case, the tip may also be formed such that the width in the left-right direction and the protrusion amount in the up-down direction of the protrusion decrease toward a locking portion.

In the above embodiment, the top layer of the claw portion 2 is formed of the same material as the top layer of the main body (the portion other than the claw portion 2) of the molding M, and the top layer of the locking piece 3 is formed of the same material as the top layer of the main body (the portion other than the locking piece 3) of the radiator grill R, but the present invention is not limited to this configuration. The top layer of the claw portion 2 may be formed of a material different from the top layer of the main body of the molding M, and the top layer of the locking piece 3 may be formed of a material different from the top layer of the main body of the radiator grill R.

The present invention may further include the following aspect. A seventh aspect of the present invention is an engagement structure between a first member mounted on a vehicle and a second member in which at least a top surface thereof is formed of a material different from the first member, the engagement structure including: a claw portion provided in either one of the first and second members; and a locking portion that is provided in the other of the first and second members and on which the claw portion is locked, wherein either one of the claw portion and the locking portion includes a protrusion in which a tip thereof heads toward and contacts the other of the claw portion and the locking portion, and the claw portion is locked on the locking portion by the tip of the protrusion contacting the other of the claw portion and the locking portion. An eighth aspect of the present invention is that in the seventh aspect, at least a top layer of the first member is formed of resin, and the second member has the top layer formed of a metal plating layer.

What is claimed is:

1. An engagement structure through which members mounted on a vehicle are engaged with each other, the engagement structure comprising:
a claw portion; and
a locking portion in which at least a top layer thereof is formed of a material different from a top layer of the claw portion and on which the claw portion is locked,
wherein either one of the claw portion and the locking portion includes a protrusion in which a tip thereof heads toward and contacts the other of the claw portion and the locking portion, and
wherein the claw portion is locked on the locking portion by the tip of the protrusion contacting the other of the claw portion and the locking portion.

2. The engagement structure according to claim 1, wherein the either one of the claw portion and the locking portion includes a plate-shaped base supporting the protrusion, and
wherein the protrusion is erected on a surface of the base, and the tip is provided so as to head in a first direction parallel to the surface of the base.

3. The engagement structure according to claim 2, wherein the tip is arranged at an end of the protrusion in a second direction parallel to the surface of the base and orthogonal to the first direction in which the tip heads.

4. The engagement structure according to claim 2, wherein a surface of the protrusion at an end thereof in a second direction parallel to the surface of the base and orthogonal to the first direction in which the tip heads is flush with a surface of the base at an end thereof in the second direction.

5. The engagement structure according to claim 1, wherein at least the top layer of the locking portion is formed of resin, and the top layer of the claw portion is formed of a metal plating layer.

6. The engagement structure according to claim 1, wherein the tip is formed such that a width and a protrusion amount of the protrusion decrease toward the locking portion.
